(19) United States
(12) Patent Application Publication
(10) Pub. No.: US 2007/0106668 A1
(43) Pub. Date: May 10, 2007

(54) File management system, information processing apparatus, authentication system, and file access authority setting system

(75) Inventors: Atsushi Maegawa, Tokyo (JP); Shuji Igawa, Tokyo (JP); Keiji Ogasawara, Tokyo (JP)

Correspondence Address: EDWARDS & ANGELL, LLP, P.O. BOX 55874, BOSTON, MA, 02205, US

(73) Assignee: Chial and Associates C. Lrd., Tokyo (JP)

(21) Appl. No.: 11/263,872

(22) Filed: Oct. 31, 2005

(30) Foreign Application Priority Data
Oct. 24, 2005 (JP) 2005-308643

(51) Int. Cl. G06F 17/30

(52) U.S. Cl. 707/9

(57) ABSTRACT

A file management system according to the present invention includes a server apparatus and a client apparatus. The server apparatus includes a file server, a file information database, an authority database, and a server-side communication section for sending a file and access authority information to the client apparatus. The client apparatus includes a client-side communication section, an application program for making a user utilize the file received by the client-side communication section, and an application controlling section for restricting a function of an application capable of being utilized by the user based on the access authority information received by the client-side communication section when the user utilizes the file received by the client-side communication section.

### CROSS REFERENCE TO RELATED APPLICATION

The present application claims priority from a Japanese Patent Application No. 2005-308643 filed on Oct. 24, 2005, the contents of which are incorporated herein by reference.

### BACKGROUND OF THE INVENTION

1. Field of the Invention

The present invention relates to a file management system, an information processing apparatus, an authentication system, and a file access authority setting system. More particularly, the present invention relates to a file management system and an information processing apparatus that make a user under a client apparatus use a file stored on a server apparatus, an authentication system that authenticates a user of a software installed in the client apparatus bymeans of the server apparatus, and a file access authority setting system.

2. Description of Related Art

An application controlling apparatus and an application controlling method for improving security during executing an application by means of an IC card are proposed as disclosed, for example, in Japanese Patent Application Publication No. 2005-92499. According to the invention disclosed in Japanese Patent Application Publication No. 2005-92499, a password in the IC card of a user is authenticated and then the user is authenticated. Then, after a user authentication has been performed successfully, it is decided whether a predetermined condition (for example, a condition such as for a certain period or when an operation for an application has not been performed) is satisfied in a state where the user can utilize the application. Then, when the predetermined condition is satisfied, the use of the application is regulated.

However, although the use of the application is regulated in the invention disclosed in Japanese Patent Application Publication No. 2005-92499, the use of data such as a folder or a file has not been regulated. Therefore, a user capable of utilizing an application can freely perform operations such as editing, archiving, and deletion of a file used by the application, regardless of whether the file is confidential information. In other words, in the invention disclosed in Japanese Patent Application Publication No. 2005-92499, it is difficult to monitor and control the handling of a confidential information file, and thus irregular access and irregular operation to the confidential information file may not be obviated.

### SUMMARY OF THE INVENTION

Therefore, it is an object of the present invention to provide a file management system, an information processing apparatus, an authentication system, and a file access authority setting system that can solve the foregoing problems. The above and other objects can be achieved by combinations described in the independent claims. The dependent claims define further advantageous and exemplary combinations of the present invention.

To solve this problem, according to the first aspect of the present invention, there is provided a file management system that makes a user under a client apparatus utilize a file stored on a server apparatus. The server apparatus includes: a file information database for storing a file position in association with a file name; a file server for storing a file at a file position stored on the file information database; an authority database for storing access authority information indicative of access authority to a file for each user in association with a plurality of file names stored on the file information database; and a server-side communication section for sending the file stored on the file server and the access authority information stored on the authority database to the client apparatus, and the client apparatus includes: a client-side communication section for receiving the file and the access authority information sent from the server-side communication section; an application program for making a user utilize the file received by the client-side communication section; and an application controlling section for restricting a function of an application capable of being utilized by the user based on the access authority information received by the client-side communication section when the user utilizes the file received by the client-side communication section.

Moreover, the client apparatus may further include an operating system for controlling operations of the application program, and the application controlling section restricts a function of the utilizable application program by controlling the application program without controlling the operating system. Moreover, the application controlling section may restrict a function of the utilizable application program by controlling the application program so that at least a part of function menus displayed by the application program cannot be selected, based on the access authority information received by the client-side communication section. Further, the application controlling section may restrict a function of the utilizable application program by graying out at least a part of function menus displayed by the application program, based on the access authority information received by the client-side communication section.

Furthermore, the client apparatus may further include: a hardware ID acquiring section for acquiring a hardware ID identifying a hardware included in the client apparatus; an authentication ID generating section for generating an authentication ID from the hardware ID acquired by the hardware ID acquiring section; and a client-side authentication-data generating section for generating authentication data including the authentication ID generated from the authentication ID generating section, the client-side communication section may send the authentication data generated from the client-side authentication-data generating section to the server apparatus, the server-side communication section may receive the authentication data sent from the client-side communication section sent, the server apparatus may further include: an authentication database for previously storing authentication ID every user; a server-side authentication-data generating section for generating authentication data including the authentication ID stored on the authentication database; and an authentication section for deciding whether the authentication data received by the server-side communication section is identical with the authentication data generated from the server-side authentication-data generating section, in order to perform authentication, and the server-side communication section may send the file stored on the file server and the access authority information stored on the authority database to the client apparatus when the authentication by the authentication section has been performed successfully.

Furthermore, the authentication database may store the authentication ID in association with user identification information identifying the user, the client-side communication section may send the authentication data generated from the client-side authentication-data generating section to the server apparatus, the server-side communication section may receive the authentication data sent from the client-side communication section, and the server-side authentication-data generating section may generate authentication data including the authentication ID stored on the authentication database in association with the user identification information included in the authentication data received by the server-side communication section. Moreover, the client-side authentication-data generating section may generate authentication data including the authentication ID generated from the authentication ID generating section and a password input from the user, the client-side communication section may send the authentication data generated from the client-side authentication-data generating section to the server apparatus, the server-side communication section may receive the authentication data sent from the client-side communication section, and the server-side authentication-data generating section may generate authentication data including the authentication ID and a password stored on the authentication database.

Moreover, the client apparatus may further include an installation time storing section for storing the time at which a software functioning as the application controlling section is installed, and the authentication ID generating section may generate an authentication ID from the installation time stored on the installation time storing section and the hardware ID acquired by the hardware ID acquiring section. Further, the client apparatus may further include an operating system for controlling operations of the application program; and a login information acquiring section for acquiring login information input from the user when logging in the operating system, and the authentication ID generating section may generate an authentication ID from the login information acquired by the login information acquiring section, the installation time stored on the installation time storing section, and the hardware ID acquired by the hardware ID acquiring section.

Furthermore, the client apparatus may further include: a client-side key generating section for generating an encryption key and a decryption key from the authentication data generated from the client-side authentication-data generating section; a client-side encryption section for encoding data to be sent from the client-side communication section to the server apparatus by means of the encryption key generated from the client-side key generating section; and a client-side decryption section for decoding data received by the client-side communication section from the server apparatus by means of the decryption key generated from the client-side key generating section, and the server apparatus may further include: a server-side key generating section for generating an encryption key and a decryption key from the authentication data generated from the server-side authentication-data generating section; a server-side encryption section for encoding data to be sent from the server-side communication section to the client apparatus by means of the encryption key generated from the server-side key generating section; and a server-side decryption section for decoding data received by the server-side communication section from the client apparatus by means of the decryption key generated from the server-side key generating section.

Moreover, the application controlling section may load the file received by the client-side communication section as a temporary file, in order to make the application program utilize the file. Further, the application controlling section may send, when the user requests the storage of a file loaded as a temporary file, the file from the client-side communication section to the server apparatus to save the file in the file server and then overwrite thereon the file loaded as the temporary file to be a new file. Moreover, the client apparatus may further include: an authority input controlling section for making the user input access authority to the file stored on the authority database; and an authority setting section for making the client-side communication section send access authority information indicative of the access authority input by the user to the server apparatus, in order to make the authority database record therein the access authority information.

Furthermore, the client apparatus or the server apparatus may further include an authority setting approving section for permitting the user, to which predetermined access authority is given, to give access authority more restricted than the predetermined access authority to another user. Moreover, the file server may store a file classified into folders, and the authority setting approving section may permit a folder administrator that is an administrator of a folder to give access authority to a file in the folder to another user. Further, the authority setting approving section may permit a file creator that is a creator of a file to give access authority to the file to another user. Moreover, the authority setting approving section may permit a server administrator that is an administrator of the server apparatus to give access authority to the file stored on the authority database to another user.

The summary of the invention does not necessarily describe all necessary features of the present invention. The present invention may also be a sub-combination of the features described above.

According to the present invention, since a sever apparatus can authenticate a user based on a hardware ID of a client apparatus, it is possible to strongly prevent a user capable of not being authenticated from getting access to the server apparatus. Moreover, individual access authority can be set every user using the client apparatus and every folder or file. Further, since the file handling of the user can be controlled and monitored by controlling an application program based on the set access authority, only the user having the file access authority can utilize a file and the user can utilize the file with the restricted access authority by restricting the file access authority of the user. In this way, it is possible to efficiently and strongly realize appropriate control of access to the file and monitoring and control of irregular operations of access to the file.

### BRIEF DESCRIPTION OF THE DRAWINGS

FIG. 1 is a schematic diagram of a file management system.

FIG. 2 is a block diagram showing a functional configuration of a server apparatus.

FIG. 3 is a view showing an authority database.

FIG. 4 is a conceptual diagram showing file access authority.

FIG. 5 is a view showing an authentication database.

FIG. 6 is a view showing a file information database.

FIG. 7 is a view showing a log database.

FIG. 8 is a block diagram showing a functional configuration of a client apparatus.

FIG. 9 is a view showing a display screen of the client apparatus.

FIG. 10 is a sequence diagram showing a flow until starting an encryption communication in the file management system.

FIG. 11 is a sequence diagram showing a flow after starting the encryption communication in the file management system.

FIG. 12 is a flowchart showing a flow of an application control process.

FIG. 13 is a sequence diagram showing a flow of a file updating.

FIG. 14 is a block diagram showing a hardware configuration of an information processing apparatus.

### DETAILED DESCRIPTION OF THE INVENTION

The invention will now be described based on the preferred embodiments, which do not intend to restrict the scope of the present invention, but exemplify the invention. All of the features and the combinations thereof described in the embodiment are not necessarily essential to the invention.

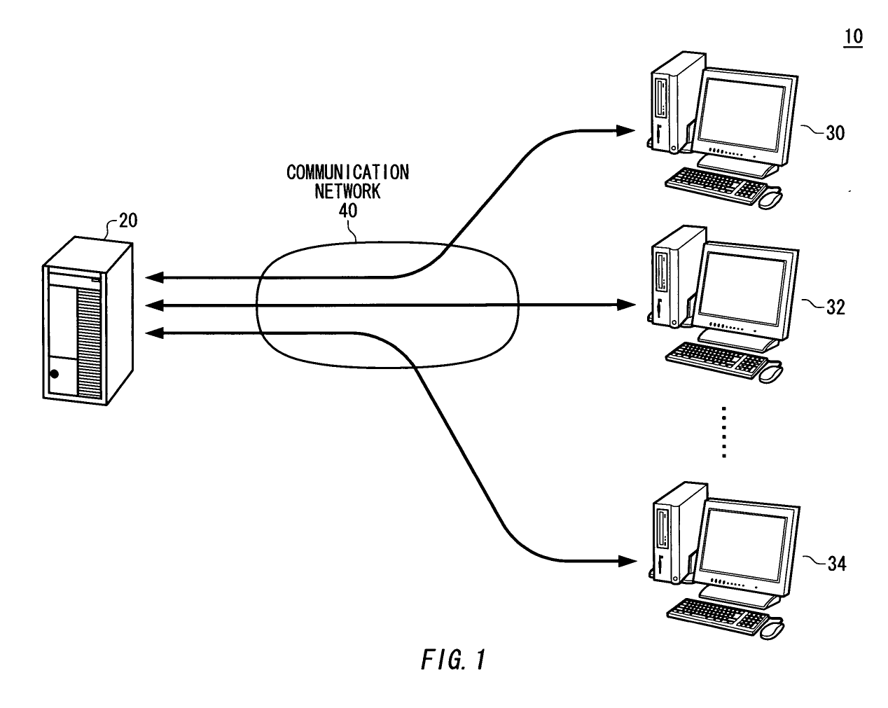

FIG. 1 shows a schematic diagram of a file management system 10 according to an embodiment of the present invention. The file management system 10 includes a server apparatus 20, a client apparatus 30, a client apparatus 32, and a client apparatus 34. The server apparatus 20 and each of the client apparatuses 30, 32, and 34 are connected to each other by a communication network 40. In addition, the file management system 10 is an example of an authentication system and a file access authority setting system as claimed in claims.

The file management system 10 according to the present embodiment separately sets access authority every user using the client apparatus 30 and every folder or file under the server apparatus 20, and authenticates a user based on information related to hardware of the client apparatus 30. Then, the file management system 10 controls an application program based on the set access authority to control and monitor the file handling of the user. Thus, the file management system 10 makes only the user having file access authority to utilize the file and makes the user utilize the file having the restricted access authority. In this way, an object of the file management system 10 is to realize safe communication, appropriate control of access to a file, and efficient monitoring and control of irregular operations of access to the file.

For example, it is considered that the system of the present invention makes a user under the client apparatus 30 utilize a file stored on the server apparatus 20. In this case, the server apparatus 20 included in the file management system 10 authenticates the user based on hardware in the client apparatus 30 utilized by the user and information to specify the user. The hardware may be, for example, a motherboard, a hard disk, a memory, and so on. The server apparatus 20 authenticates a user based on information to identify the user and information to identify the hardware.

Specifically, the server apparatus 20 previously stores an authentication ID. The authentication ID is generated from a hardware ID to identify a hardware under the client apparatus 30. Then, whenever the user requests the handling of a desired file under the client apparatus 30, the client apparatus 30 generates authentication data including the authentication ID generated from the hardware ID of the client apparatus 30 being utilized by the user and a password input by the user, and sends the authentication data and a user ID to the server apparatus 20. Then, the server apparatus 20 extracts an authentication ID and a password corresponding to the user from a database previously stored in the server apparatus 20 based on the user ID received from the client apparatus 30. Then, the server apparatus 20 generates authentication data from the extracted authentication ID and password by means of the same algorithm as that of the client apparatus 30. The server apparatus 20 collates the authentication data received from the client apparatus 30 with the authentication data generated by the server apparatus 20 to authenticate the user.

When the user has been authenticated, the server apparatus 20 generates an encryption key from the authentication data, and performs communication between the server apparatus 20 and the client apparatus 30 as encryption communication. Then, the server apparatus 20 encodes both of a file requested by the user and information related to access authority to the file of the user, and sends the encoded data to the client apparatus 30 via the communication network 40. In this case, the server apparatus 20 and the client apparatus 30 communicate with each other by means of encryption communication. In addition, the communication network 40 may be a network such as LAN, WAN, and Internet.

The client apparatus 30 decodes an encryption file and encryption access authority information received from the server apparatus 20. Then, the client apparatus 30 controls an operation of an application handling the file utilized by the user based on the information related to access authority received from the server apparatus 20. The server apparatus 20 may finely set authority, with which the user can handle the file, for each file. For example, the server apparatus 20 can set the access authority to the file of the user to perform only reading of the file. In addition, the access authority to the file may be reading, printing, editing, archiving, deleting, and copying of the file. Then, when the access authority of the user is only reading of the file, the client apparatus 30 controls an application program so that the user cannot handle editing, printing, archiving, and soon of the file. For example, in a pull-down menu of an application program, the client apparatus 30 controls the application program so that the user cannot select menus corresponding to operations without the access authority. Moreover, the client apparatus 30 sends an operation of the user along with information to identify the user and time to the server apparatus 20.

Moreover, when the user utilizes the file sent from the server apparatus 20, the client apparatus 30 loads the file as a temporary file to make the user utilize the loaded file. Then, when the user terminates the use of the file, the client apparatus 30 encodes the file loaded as a temporary file to send the encoded file to the server apparatus 20, and saves the file in the server apparatus 20. On the other hand, the client apparatus 30 overwrites that file on the file loaded as a temporary file as a new file, in order to erase the loaded file.

According to the file management system 10 of the present embodiment, since the user authentication is performed based on the hardware ID of the client apparatus 30, it is possible to strongly prevent irregular access even if an irregular user tries to access data by means of information to identify a registered user.

Moreover, according to the file management system 10 of the present embodiment, since access authority for each file can finely be set every user, it is possible to appropriately set an aspect of a file according to a user to beforehand prevent the abuse of the file effectively.

Furthermore, according to the file management system 10 of the present embodiment, since the client apparatus 30 overwrites a new file on the file utilized by the user after the user terminates the use of the file in order to erase the file utilized by the user, it is possible to prevent the client apparatus 30 from calling for the file utilized by the user.

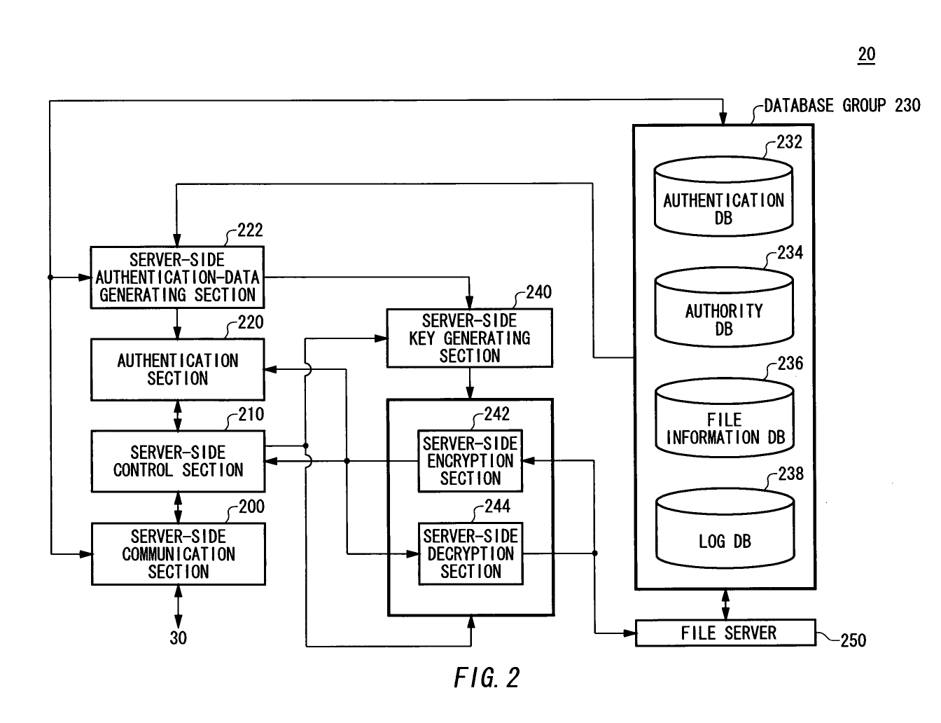

FIG. 2 is a view exemplary showing a functional configuration of the server apparatus 20 according to the present embodiment. The server apparatus 20 has a server-side communication section 200, a server-side control section 210, an authentication section 220, a server-side authentication-data generating section 222, a database group 230, a server-side key generating section 240, a server-side encryption section 242, a server-side decryption section 244, and a file server 250. Moreover, the database group 230 includes an authentication database 232, an authority database 234, a file information database 236, and a log database 238.

The file information database 236 stores an address capable of uniquely identifying a file position of a file to be stored on the file server 250 in association with its file name. The file information database 236 supplies the stored file position to the file server 250 based on the control of the server-side control section 210. Moreover, the file server 250 stores the file at the file position stored on the file information database 236. Then, the file server 250 supplies the stored file to the server-side encryption section 242 based on the control of the server-side control section 210. Specifically, the file server 250 receives a file position from the file information database 236, and supplies a file stored at the file position to the server-side encryption section 242. Moreover, the file server 250 may store a file decoded by the server-side decryption section 244 based on the control of the server-side control section 210. Specifically, the file server 250 stores a file decoded by the server-side decryption section 244. Then, the file server 250 supplies the file position at which the file is stored to the file information database 236, in order to store the position on the file information database 236.

The authority database 234 stores access authority information showing access authority to a file of each user in association with a plurality of file names stored on the file information database 236. Specifically, the authority database 234 stores access authority to a file in association with an identifier capable of uniquely identifying the file. In addition, access authority to a file may be information showing whether a user can conduct the reading of a file, the printing of a file, the editing of a file, the alias archiving of a file, the overwriting archiving of a file, the mail transmission of a file, the deletion of a file, and the taking out of a file. The authority database 234 supplies the stored access authority to the server-side control section 210 based on the control of the server-side control section 210.

The authentication database 232 previously stores an authentication ID for each user. Moreover, the authentication database 232 may store an authentication ID in association with user identification information identifying a user. The user identification information may specifically be identification information capable of uniquely identifying a user, or may be, e.g., a user ID and a password. In addition, the authentication database 232 may previously store an authentication ID generated when a user first starts to use the file management system 10 according to the present embodiment. The authentication database 232 supplies the authentication ID to the server-side authentication-data generating section 222 based on the control of the server-side control section 210.

The log database 238 stores log data that the server-side communication section 200 receives and that is information of a history obtained by the user handling a file. The log database 238 stores the history obtained by the user handling a file along with the handled time in association with an identifier capable of uniquely identifying the file. Specifically, the server-side communication section 200 first receives encoded log data transmitted from the client apparatus 30 to the server apparatus 20. Then, the server-side communication section 200 supplies the received log data to the server-side decryption section 244 based on the control of the server-side control section 210, in order to decode the encoded log data. Then, the server-side control section 210 works on the file server 250 to store the decoded log data on the log database 238.

The server-side communication section 200 sends and receives data such as a file, authentication data, and a user ID to/from the client apparatus 30. Specifically, the server-side communication section 200 receives authentication data sent from the client apparatus 30 or the like. The server-side communication section 200 supplies the received data to the server-side control section 210. Moreover, the server-side communication section 200 sends the file stored on the file server 250 and the access authority information stored on the authority database 234 to the client apparatus 30 or the like based on the control of the server-side control section 210. Then, when user authentication has been approved by the server apparatus 20, the server-side communication section 200 sends an encryption file obtained by encoding the file stored on the file server 250 and encryption access authority information obtained by encoding the access authority information stored on the authority database 234 to the client apparatus for which the user authentication has been approved. In addition, the server apparatus 20 and the client apparatus 30 or the like may communicate with each other by means of a network such as LAN, WAN, and Internet.

The server-side authentication-data generating section 222 generates authentication data including the authentication ID stored on the authentication database 232. Specifically, the server-side authentication-data generating section 222 extracts user identification information included in the authentication data received by the server-side communication section 200, and extracts the authentication ID stored on the authentication database 232 in association with the extracted user identification information. Then, the server-side authentication-data generating section 222 generates authentication data including the extracted authentication ID and the user identification information. In addition, the user identification information may be, e.g., a password associated with a user ID and a user. The server-side authentication-data generating section 222 supplies the generated authentication data to the authentication section 220 and the server-side key generating section 240.

The server-side key generating section 240 generates an encryption key encoding data such as a file and a decryption key decoding the encoded data from the authentication data received from the server-side authentication-data generating section 222, based on the control of the server-side control section 210. In addition, the server-side key generating section 240 may adopt a common key encryption method such as AES and RC4 as an encryption method. The server-side key generating section 240 supplies the generated encryption key to the server-side encryption section 242. Moreover, the server-side key generating section 240 supplies the generated decryption key to the server-side decryption section 244.

The server-side encryption section 242 encodes data to be sent from the server-side communication section 200 to the client apparatus by means of the encryption key generated from the server-side key generating section 240. For example, the server-side control section 210 works on the file server 250 to supply the file stored on the file server 250 to the server-side encryption section 242. Then, the server-side encryption section 242 encodes the received file. Moreover, the server-side encryption section 242 may encode the access authority information that is stored on the authority database 234 and that is information to be sent to the client apparatus via the server-side communication section 200, based on the control of the server-side control section 210. The server-side encryption section 242 sends the encoded data from the server-side communication section 200 to the client apparatus via the server-side control section 210.

The server-side decryption section 244 decodes data received by the server-side communication section 200 from the client apparatus by means of the decryption key generated from the server-side key generating section 240. For example, the server-side decryption section 244 decodes the encryption file received by the server-side communication section 200 from the client apparatus. The server-side decryption section 244 supplies the decoded file to the file server 250. Moreover, the server-side decryption section 244 decodes the encoded authentication data received by the server-side communication section 200 from the client apparatus. The server-side decryption section 244 supplies the decoded authentication data to the authentication section 220.

The authentication section 220 decides whether the authentication data received by the server-side communication section 200 from the client apparatus is identical with the authentication data generated from the server-side authentication-data generating section 222, in order to perform authentication. Specifically, the authentication section 220 supplies the authentication data encoded in the client apparatus, which is received from the server-side control section 210, to the server-side decryption section 244, in order to decode the encoded data. Then, the authentication section 220 receives the decoded authentication data from the server-side decryption section 244. Next, the authentication section 220 collates the authentication data generated from the server-side authentication-data generating section 222 with the decoded authentication data. The authentication section 220 supplies an authentication result to the server-side control section 210.

The server-side control section 210 controls an operation of each section included in the server apparatus 20. Specifically, the server-side control section 210 supplies the data received by the server-side communication section 200 from the client apparatus to an appropriate section included in the server apparatus 20. For example, the server-side control section 210 works on the file server 250 to supply the file stored on the file server 250 to the server-side encryption section 242. Moreover, the server-side control section 210 may work on the server-side decryption section 244 to supply the decoded file to the file server 250. Moreover, the server-side control section 210 makes the server-side communication section 200 send the encoded data, which should be send from the server apparatus 20 to the client apparatus, to the client apparatus. Then, the server-side control section 210 works on each section of the server apparatus 20 to supply predetermined data to a predetermined section and also process the section appropriately with the data.

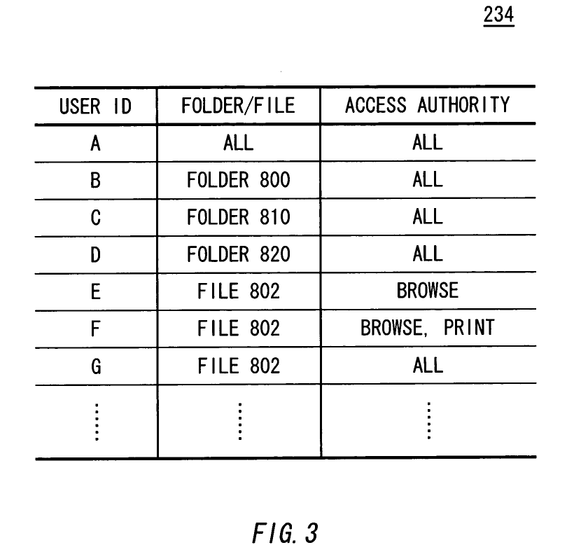

FIG. 3 is a view exemplary showing the authority database 234 according to the present embodiment. The authority database 234 stores access authority information of files and folders for each user every file and folder stored on the file server 250, in association with the plurality of file names stored on the file information database 236. Specifically, the authority database 234 stores information, e.g., a file name, to identify a folder and a file capable of being utilized by a user in association with a user ID uniquely showing the user. Then, the authority database 234 stores access authority to the folder and the file of the user.

For example, when a person having a user ID of A is an administrator of the server apparatus 20, the authority database 234 stores access authority showing that the person having a user ID of A can perform all operations (for example, reading, printing, editing, deleting, archiving, copying, mail sending, and taking out) on all folders and all files stored on the server. Moreover, the authority database 234 may store access authority of a folder administrator managing the folder every folder. For example, when a person having a user ID of B is a folder administrator of a folder 800, the authority database 234 stores access authority showing that the person having a user ID of B can perform all operations on a file classified into the folder 800.

Moreover, the authority database 234 stores access authority by which the user can handle the file every file. For example, the authority database 234 stores access authority by which a person having a user ID of E can only read a file 802. Moreover, the authority database 234 stores access authority by which a person having a user ID of F can only read or print a file 802. On the other hand, the authority database 234 stores access authority by which a person having a user ID of G can perform all operations on a file 802. In this manner, the authority database 234 stores information showing folder(s) and file(s) capable of being utilized by a user and access authority by which the user can handle that folder(s) and that file(s), for each user.

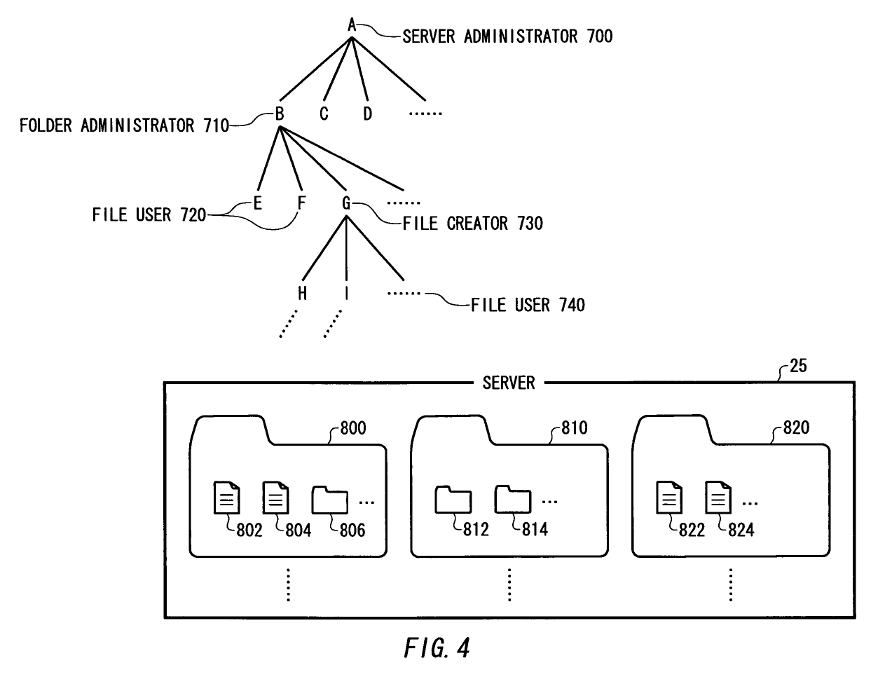

FIG. 4 is a conceptual diagram showing a hierarchical structure of file access authority according to the present embodiment. Moreover, FIG. 4 is a view exemplary showing a conceptual server apparatus 25. The conceptual server apparatus 25 stores a folder 800, a folder 810, a folder 820, and so on. Further, the folder 800 includes a file 802, a file 804, a folder 806, and so on. Moreover, the folder 810 includes a folder 812, a folder 814, and so on. Further, the folder 820 includes a file 822, a file 824, and so on.

The person having a user ID of A that is a server administrator 700 has the whole access authority capable of utilizing all folders and files in the conceptual server apparatus 25. Further, the server administrator 700 can set a plurality of persons as a folder administrator 710 managing a folder. For example, the server administrator 700 can set persons having the user IDs of B, C, and D as the folder administrator 710. The server administrator 700 can set folder(s) and file(s) capable of being utilized by the folder administrator 710 for each folder administrator 710. The folder administrator 710 may have the whole access authority to the folders set to the server administrator 700. Moreover, the server administrator 700 may set the folder administrator 710 to have restricted access authority to the folder. The access authority set by the server administrator 700 is stored on the authority database 234.

For example, the server administrator 700 can specify the persons different from one another with respect to the folder 800, the folder 810, and the folder 820, in order to set them as the folder administrator 710. For example, the server administrator 700 may set the person having the user ID of B on the folder 800, the person having the user ID of C on the folder 810, and the person having the user ID of D on the folder 820, as the folder administrator 710. Moreover, the server administrator 700 may set the folder administrator 710 to manage a plurality of folders. Moreover, the server administrator 700 may set the folder administrator 710 to have the restricted access authority to a folder and a file. For example, the server administrator 700 may restrict predetermined authority such as the deletion of a file classified into the folder managed by the folder administrator 710, with respect to a predetermined folder administrator 710.

The folder administrator 710 can further set access authority of a file user 720 to a file classified into the folder managed by the folder administrator 710, within the folders(s) and the access authority set to the server administrator 700. For example, the folder administrator 710 having the user ID of B can set access authority of the persons having the user IDs of E, F, and G to the file 802, the file 804, and the folder 806 classified into the folder 800 managed by the folder administrator 710. In this case, the folder administrator 710 can set access authority to a file for each user. For example, the folder administrator 710 sets the access authority capable of only reading the file 802 with respect to the person having the user ID of E. Moreover, the folder administrator 710 may set the access authority capable of only reading or printing the file 802 with respect to the person having the user ID of F. The access authority set by the folder administrator 710 is stored on the authority database 234.

Furthermore, when the person having the user ID of G is a file creator 730 who has made the file 802, the person having the user ID of G can freely set access authority of other file users 740 (e.g., persons having the user IDs of H and I) on the file made by himself. The access authority set by the file creator 730 is stored on the authority database 234.

According to the file management system 10 of the present embodiment, the server administrator 700 can specify the folder(s) and the file(s) capable of being handled by the user every user, in order to store access authority set to the specified folder(s) and the file(s). That is, according to the file management system 10, since file (s) capable of being utilized by the user and access authority capable of handling the file (s) can be stored for each user, it is possible to appropriately manage a folder and a file even if the file management system 10 is managed without a server administrator after a management condition of the folder and the file has been set once.

Moreover, the file management system 10 according to the present embodiment can hierarchically classify administrators and users into a server administrator 700, folder administrators 710, and so on, and set access authority to a file for each hierarchy. That is, according to the file management system 10, since a high-order administrator can set a low-order administrator within the access authority of the administrator, it is possible to prevent each user from enlarging access authority to a file without any restriction.

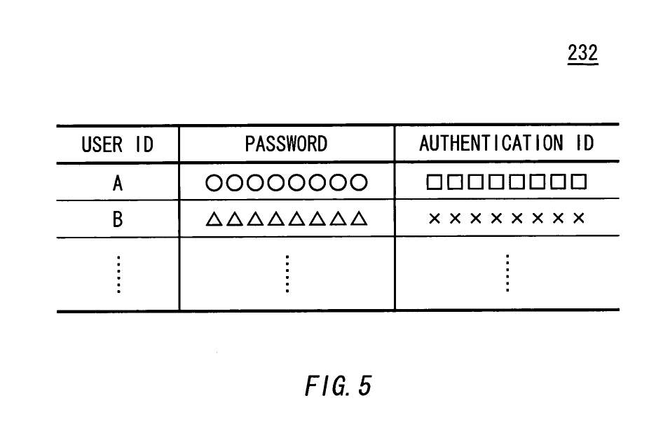

FIG. 5 is a view exemplary showing the authentication database 232 according to the present embodiment. The authentication database 232 stores a password and an authentication ID of a user in association with a user ID capable of uniquely identifying the user. Moreover, the authentication database 232 may store personal information of a user, e.g., a full name, a department name, and a post in association with the user ID.

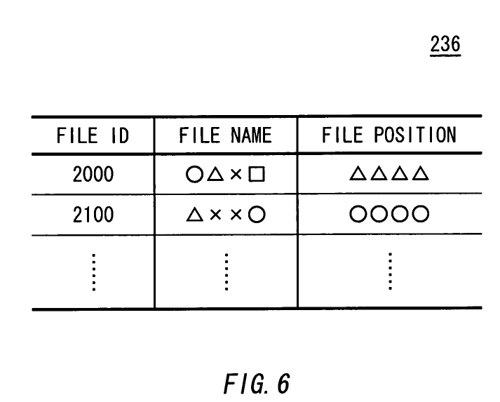

FIG. 6 is a view exemplary showing the file information database 236 according to the present embodiment. The file information database 236 stores a file position of a file corresponding to a file name in the file server 250 in association with the file ID and the file name capable of uniquely identifying the file.

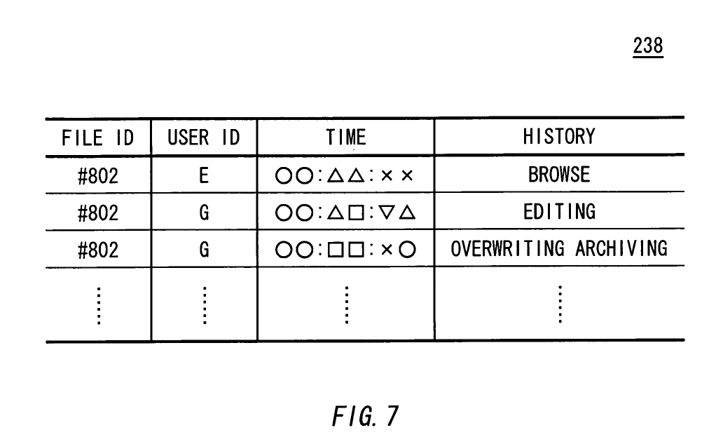

FIG. 7 is a view exemplary showing the log database 238 according to the present embodiment. The log database 238 stores a work history of a user conducted for file data corresponding to a file ID in association with the file ID. Specifically, the log database 238 stores a history or the like showing a user ID, time at which a user performs a predetermined operation using the file, and a work description, in association with the file ID. Moreover, the log database 238 may store an IP address of the client apparatus in which the user has handled the file, a full name of the user or the like. For example, the log database 238 stores information indicative of a “reading” operation, which the person having the user ID of E has conducted for the file 802 corresponding to the file ID #802, along with the time at which the operation has been performed.

According to the file management system 10 of the present embodiment, since all operations handling the file of the user can be stored on the log database 238, the server administrator 700 can monitor and manage all operations handling the file of the user any time.

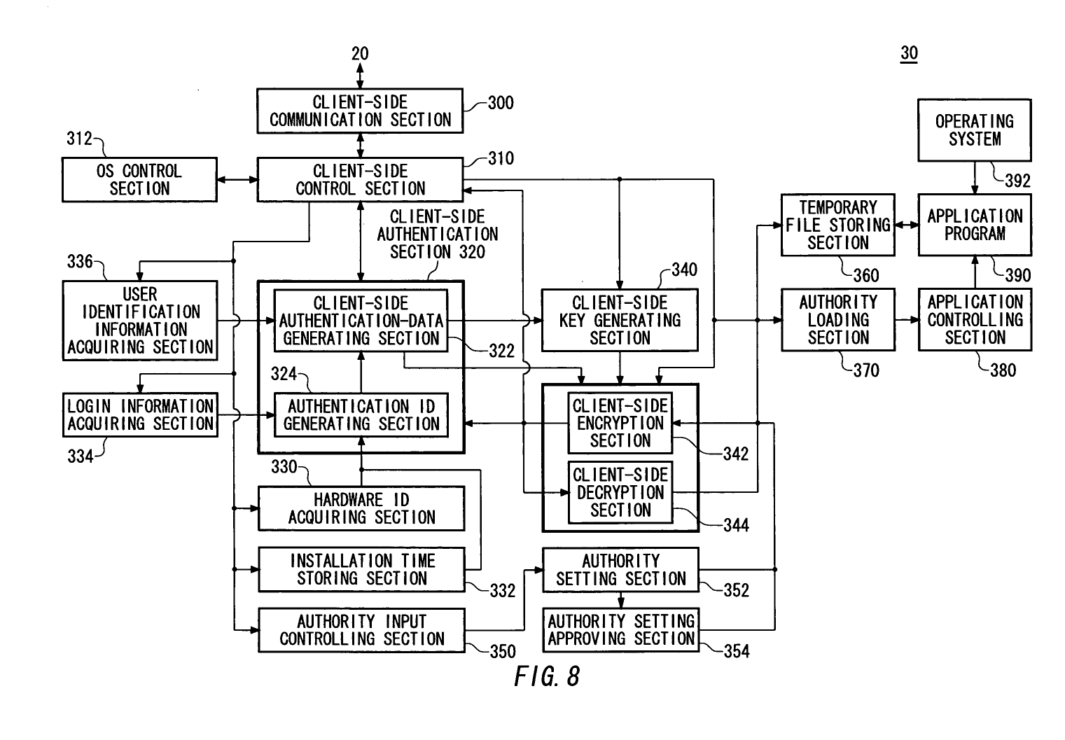

FIG. 8 is a view exemplary showing a functional configuration of the client apparatus 30 according to the present embodiment. The client apparatus 30 has a client-side communication section 300, a client-side control section 310, an operating system control section 312, a client-side authentication section 320, a hardware ID acquiring section 330, an installation time storing section 332, a login information acquiring section 334, a user identification information acquiring section 336, a client-side key generating section 340, a client-side encryption section 342, a client-side decryption section 344, an authority input controlling section 350, an authority setting section 352, an authority setting approving section 354, a temporary file storing section 360, an authority loading section 370, an application controlling section 380, an application program 390, and an operating system 392. Moreover, the client-side authentication section 320 includes a client-side authentication-data generating section 322 and an authentication ID generating section 324. In addition, the client apparatus 30 is an example of an information-processing apparatus as claimed in claims.

The hardware ID acquiring section 330 acquires a hardware ID identifying hardware included in the client apparatus 30 based on the control of the client-side control section 310. A hardware ID may be, e.g., a model number and a serial number of a manufacturer of a hard disk drive included in the client apparatus 30 and a serial number of a motherboard in the client apparatus 30. Here, the hardware ID is different from one another every client apparatus. Further, a hardware ID can uniquely be decided every client apparatus. The hardware ID acquiring section 330 supplies the acquired hardware ID to the authentication ID generating section 324 based on the control of the client-side control section 310.

When logging in an operating system, the login information acquiring section 334 acquires login information input from a user. For example, the login information may be a log in account and a password every user. The log in information acquiring section 334 supplies the acquired login information to the authentication ID generating section 324 based on the control of the client-side control section 310. The installation time storing section 332 stores the time at which software functioning as the application controlling section 380 in the client apparatus 30 is installed. The installation time storing section 332 supplies the stored installation time to the authentication ID generating section 324 based on the control of the client-side control section 310.

The authentication ID generating section 324 generates an authentication ID from the hardware ID acquired by the hardware ID acquiring section 330, the installation time stored on the installation time storing section 332, and the login information acquired by the login information acquiring section 334, based on the control of the client-side control section 310. Specifically, the authentication ID generating section 324 generates an authentication ID uniquely corresponding to each user from the hardware ID received from the hardware ID acquiring section 330, the installation time, and the login account of the user. In addition, the authentication ID generating section 324 may generate an authentication ID from the hardware ID and the installation time. When a user handles a file in the client apparatus 30 according to the present embodiment, the authentication ID generating section 324 may generate an authentication ID every time whenever software functioning as the application controlling section 380 is started. The authentication ID generating section 324 supplies the generated authentication ID to the client-side authentication-data generating section 322 based on the control of the client-side control section 310.

The user identification information acquiring section 336 acquires user identification information that is information to identify a user uniquely. For example, user identification information may be a user ID and a password. The user identification information acquiring section 336 supplies the user identification information to the client-side authentication-data generating section 322 based on the control of the client-side control section 310. The client-side authentication-data generating section 322 generates authentication data including the authentication ID generated from the authentication ID generating section 324. Moreover, the client-side authentication-data generating section 322 may generate authentication data including the authentication ID received from the authentication ID generating section 324 and the user identification information received from the user identification information acquiring section 336. The client-side authentication-data generating section 322 supplies the generated authentication data to the client-side key generating section 340 and the client-side encryption section 342, based on the control of the client-side control section 310.

The client-side key generating section 340 generates an encryption key and a decryption key from the authentication data received from the client-side authentication-data generating section 322 based on the control of the client-side control section 310. In addition, the client-side key generating section 340 may adopt a common key encryption method such as AES and RC4 as an encryption method. The client-side key generating section 340 supplies the generated encryption key to the client-side encryption section 342. Moreover, the client-side key generating section 340 supplies the generated decryption key to the client-side decryption section 344.

The client-side encryption section 342 encodes data to be sent from the client apparatus 30 to the server apparatus 20 by means of the encryption key received from the client-side key generating section 340, based on the control of the client-side control section 310. For example, after the user conducts a predetermined operation on a file received from the server apparatus 20 and updates the file, the client-side encryption section 342 encodes the updated file. The client-side encryption section 342 supplies the encoded data to the client-side control section 310.

The client-side decryption section 344 decodes data, which the client apparatus 30 receives from the server apparatus 20, by means of the decryption key received from the client-side key generating section 340 based on the control of the client-side control section 310. Specifically, the client-side decryption section 344 decodes each encoded data such as the encoded access authority information and the encoded file data that the client-side control section 310 receives from the server apparatus 20 via the client-side communication section 300. The client-side decryption section 344 supplies the decoded access authority information to the authority loading section 370 based on the control of the client-side control section 310. Moreover, the client-side decryption section 344 supplies the decoded file data to the temporary file storing section 360 based on the control of the client-side control section 310.

The client-side communication section 300 receives the file sent by the server-side communication section 200 and stored on the file server 250 and access authority information indicative of access authority of the file stored on the authority database 234 in association with the file. Moreover, the client-side communication section 300 sends the authentication data generated from the client-side authentication-data generating section 322 to the server apparatus 20 based on the control of the client-side control section 310. The client-side communication section 300 supplies the file and the access authority information received from the server apparatus 20 to the client-side control section 310. In addition, both of the file and the access authority information received from the server apparatus 20 may be encoded.

The temporary file storing section 360 loads the decoded file received from the client-side decryption section 344 as a temporary file based on the control of the application controlling section 380, in order to make the application program 390 utilize the loaded file. When the user has finished the use of the file, the temporary file storing section 360 supplies the file to the client-side encryption section 342. Moreover, the temporary file storing section 360 erases the imprint of the stored file based on the control of the application controlling section 380 when the user has finished the use of the file. The authority loading section 370 loads the access authority information received from the client-side decryption section 344. Then, the authority loading section 370 supplies the access authority information to the application controlling section 380.

The application program 390 makes the user utilize the file received by the client-side communication section 300. Specifically, the application program 390 corresponding to the temporary file loaded by the operating system 392 on the temporary file storing section 360 is called based on the control of the client-side control section 310. Then, the called application program 390 makes the user utilize the file received by the client-side communication section 300. For example, the application program 390 may be software such as MS-Office (a registered trademark). Moreover, the application program 390 may be software such as Acrobat Reader (a registered trademark). The operating system 392 controls operations of the application program 390. For example, the operating system 392 may be Windows (a registered trademark).

The operating system control section 312 works on the client-side control section 310, in order to make the client-side control section 310 perform the control of input devices (a keyboard, a mouse, and so on) included in the client apparatus 30, the login control, the regular monitoring of a clipboard, the control of system lock, and so on. Specifically, the operating system control section 312 controls that the user manipulates a copy of the file or the like by an operation of the keyboard. For example, when the user does not have access authority to a copy of the file, the operating system control section 312 works on the client-side control section 310 to prohibit the user from copying the file using the keyboard.

Moreover, when the file transmitted from the server apparatus 20 is loaded on the temporary file storing section 360, the operating system control section 312 may start and station a keyboard controlling module for performing control such that information related to a predetermined keyboard operation is not supplied to the operating system, in order to invalidate operations using a control key of the keyboard. Moreover, the operating system control section 312 may include a regular monitoring module for performing a keyboard operation capable of taking out information using the control key and the monitoring of API calling the clipboard. The regular monitoring module supplies information related to the keyboard operation of the user to the keyboard controlling module. The keyboard controlling module controls the operations of the keyboard based on the information supplied from the regular monitoring module.

The application controlling section 380 restricts the application function capable of being utilized by the user based on the access authority information received by the client-side communication section 300 when making the user utilize the file received by the client-side communication section 300. In this case, the application controlling section 380 restricts a function of an utilizable application program by controlling an application without controlling the operating system. Since the application controlling section 380 does not control the operating system, that is, does not interrupt operations of the operating system, it is possible to ensure a stable operation without conflicting with the other functions of the operating system.

Moreover, the application controlling section 380 may restrict a function of the utilizable application program by controlling the application program so that at least a part of the functional menus displayed by the application program cannot be selected, based on the access authority information received by the client-side communication section 300. For example, when the access authority to a predetermined file of a predetermined user is only reading of the file, the application controlling section 380 may make the user utilize only a functional menu such as the closing of the file and restrict the other functional menus (copying, archiving, sending, and so on) by graying out the menus to be unable to be selected. Moreover, the application controlling section 380 may make the user be unable to select the functional menus of the application program, to which the user does not have access authority, by not displaying the menus so that the user cannot select the menus.

Furthermore, the application controlling section 380 loads the file received by the client-side communication section 300 on the temporary file storing section 360 as a temporary file, to make the application program 390 utilize the loaded file. Then, when the user requests the archiving of the file loaded on the temporary file storing section 360, the application controlling section 380 sends the file from the client-side communication section 300 to the server apparatus 20 to store the sent file on the file server 250. Specifically, the application controlling section 380 supplies the file from the temporary file storing section 360 to the client-side encryption section 342. Then, the client-side encryption section 342 encodes the received file to supply the encoded file to the client-side control section 310. Next, the client-side control section 310 sends the received encoded file to the server apparatus 20 via the client-side communication section 300. Then, the application controlling section 380 overwrites the file loaded on the temporary file storing section 360 as a new file. Moreover, the application controlling section 380 may delete the file overwritten as a new file after that.

The client apparatus 30 according to the present embodiment loads the file received from the server apparatus 20 as a temporary file. Then, when the user has finished the operations for the file, the client apparatus 30 overwrites and holds a new file on the temporary file. In this way, since the whole index information of the temporary file is rewritten and becomes blank, it is possible to prevent a malicious user from accessing file data stored on the client apparatus 30.

The client-side control section 310 controls an operation of each section included in the client apparatus 30. Specifically, the client-side control section 310 supplies the data, which the client-side communication section 300 receives from the server apparatus 20, to an appropriate section included in the client apparatus 30. Moreover, the client-side control section 310 makes the client-side communication section 300 transmit the encrypted data, which should be sent from the client apparatus 30 to the server apparatus 20, to the server apparatus 20. Then, the client-side control section 310 works on each section of the client apparatus 30, in order to supply predetermined data to a predetermined section and perform a predetermined process on the section using the data.

The authority input controlling section 350 makes the user input access authority to the file stored on the authority database 234. The authority input controlling section 350 supplies the input access authority to the file to the authority setting section 352. The authority setting section 352 sends access authority information showing the access authority input from the user from the client-side communication section 300 to the server apparatus 20, in order to make the authority database record the information.

The authority setting approving section 354 allows the user having a predetermined authority to give access authority more restricted than the predetermined access authority to other users. For example, the authority setting approving section 354 allows the user having access authority such as reading, printing, and deleting as the access authority to a predetermined file to give at least a part of reading, printing, and deleting within the access authority to other users. Moreover, the authority setting approving section 354 allows a folder administrator that is an administrator of a folder to give access authority to files in the folder to other users. Specifically, the authority setting approving section 354 allows the folder administrator to give access authority to files classified into the folder, which is managed by the folder administrator, to other users. For example, the authority setting approving section 354 can allow the folder administrator to give access authority to other users different from one another every file among a plurality of files and allow the folder administrator to give access authority different from one another every file among a plurality of files.

Furthermore, the authority setting approving section 354 allows a file creator that is a creator of a file to give access authority to the file to other users. Specifically, the authority setting approving section 354 allows the file creator to give access authority to the file to other users for the only file created by the file creator. In this case, the authority setting approving section 354 may allow the file creator to restrict the access authority to the file and give the restricted access authority to other users. Then, the authority setting approving section 354 allows a server administrator that is an administrator of the server apparatus 20 to give access authority to the file stored on the authority database 234 to other users. Since the server administrator has access authority to all folders and files stored on the server apparatus 20, the authority setting approving section 354 may allow the server administrator to set access authority different from one another every folder and file to give the set access authority to other users. In addition, the authority setting approving section 354 may be included in the server apparatus 20.

The file management system 10 of the present embodiment can generate an authentication ID from the hardware ID of the client apparatus 30 utilized by the user, the time at which the software functioning as the application controlling section 380 is installed, and the login information (e.g., a user account). Then, the file management system 10 can generate authentication data from the generated authentication ID and user identification information (e.g., a password) in order to send the authentication data to the server apparatus 20 for user authentication. Since such an authentication ID is uniquely generated from the user and the hardware utilized by the user, a third party cannot be authenticated even if the third party attempts user authentication by means of user identification information of the user in a client apparatus different from the client apparatus 30 utilized by the user. Moreover, although a third party attempts user authentication in the client apparatus 30 utilized by the user, the user authentication cannot be realized with user identification information different from the user identification information of the user. In this way, since the file management system 10 according to the present embodiment authenticates a user based on a hardware ID when the user accesses the server apparatus 20 via the client apparatus 30, it is possible to strongly prevent a user not having access authority from accessing the system by identity theft.

Moreover, since the file management system 10 according to the present embodiment can finely set access authority to a file in the server apparatus 20, for each server administrator, each folder administrator, and each user, and for each folder and each file, it is possible to efficiently and strongly prevent a leak and an irregular use in relation to the handling of the file even if the server administrator is absence after the setting of the access authority.

Furthermore, according to the file management system 10 of the present embodiment, the files, which are utilized by the user in the client apparatus 30, are sent to the server apparatus 20 after the files have been used by the user and are uniformly managed in the server apparatus 20. Then, the file, which is loaded by the client apparatus 30 as a temporary file, is overwritten by a new file to be saved, in order to prevent the user from accessing the file after the file has been used by the user. In this way, it is possible to uniformly manage a server that does not store data locally and prevent confidential files from being distributed.

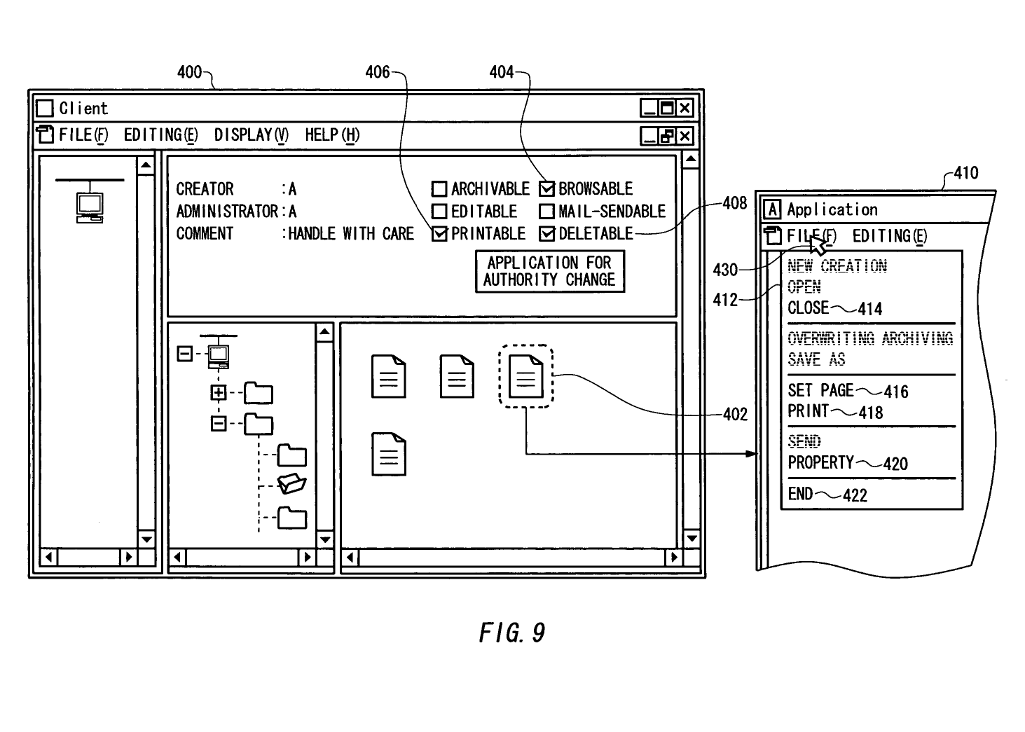

FIG. 9 is a view exemplary showing a display screen of the client apparatus 30 according to the present embodiment. When the user starts the software functioning as the application controlling section 380, the client screen 400 is displayed on a display apparatus such as a monitor included in the client apparatus 30. There are displayed server information of the server for which the user has access authority capable of at least “reading” the file, each folder, and each file on the client screen 400. Furthermore, access authority given to the user every folder and every file is displayed on the client screen 400.

For example, it is considered that the user selects the file 402. When access authority to the file 402 given to the user is reading, printing, and deleting, there are checked and displayed a check box 404, a check box 406, and a check box 408 corresponding to work names having access authority in a column showing access authority of the user as well as information related to the file 402, on the client screen 400. In addition, there may be displayed information such as a creator and an administrator of the file 402 on the client screen 400 as information related to the file 402.

Subsequently, it is considered that an application handling the file 402 is started by the user opening the file 402 by a clicking operation. In this case, the application controlling section 380 controls the application program based on the access authority of the user so that at least a part of functional menus cannot be selected. For example, in the application using screen 410 of the started application program, it is considered that the user clicks a “FILE” menu using a pointer 430. In this case, a plurality of functional menus included in the “FILE” menu is displayed as a pull-down menu 412. Then, the application controlling section 380 grays out functional menus corresponding to works for which the user does not have access authority, and controls the application so that the user cannot select the menus. On the other hand, the application controlling section 380 displays functional menus corresponding to works for which the user has access authority and functional menus capable of being utilized by the user even if the user does not have access authority, so that the user can select these menus. For example, the application controlling section 380 displays a functional menu 414, a functional menu 416, a functional menu 418, a functional menu 420, and a functional menu 422, so that the user can select these menus.

The client apparatus 30 according to the present embodiment displays only editing menus corresponding to access authority to the file given to the user as a selectable editing menu when the user opens the file using a predetermined application program. On the other hand, since editing menus corresponding to access authority to the file not given to the user are displayed so that the user cannot select these menus, it is possible to surely prevent the user from performing operations not having access authority.

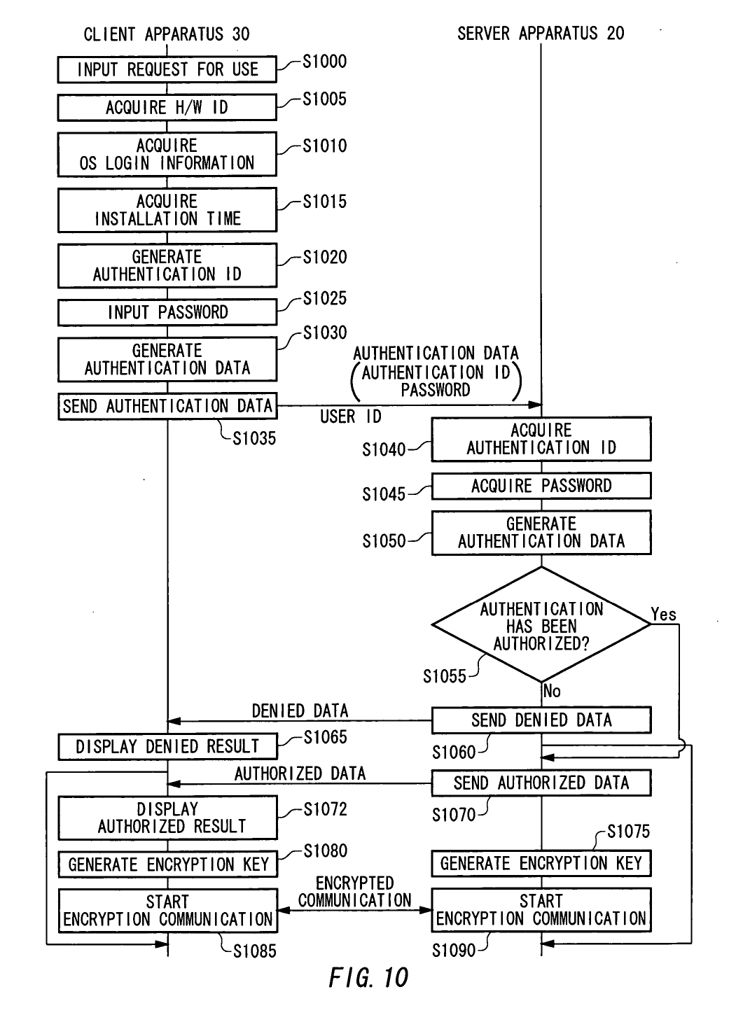

FIG. 10 is a view exemplary showing a flow of a process until starting encryption communication in the file management system 10 according to the present embodiment. At first, a user starts software for controlling functions of an application capable of being utilized by the user, and inputs a use request of the software, in the client apparatus 30 (S1000). Subsequently, the hardware ID acquiring section 330 acquires a hardware ID (S1005). The hardware ID acquiring section 330 supplies the acquired hardware ID to the authentication ID generating section 324.

Then, the login information acquiring section 334 acquires login information input to an operating system by the user (S1010). For example, the login information acquiring section 334 acquires login information such as a user account and a password input when the user logs in the client apparatus 30. The login information acquiring section 334 supplies the acquired login information to the authentication ID generating section 324. Furthermore, the client-side control section 310 works on the installation time storing section 332, and acquires the time at which software for controlling functions of the application capable of being utilized by the user is installed in the client apparatus 30 being now utilized by the user (S1015). The client-side control section 310 makes the installation time storing section 332 supply the acquired installation time to the authentication ID generating section 324. Next, the authentication ID generating section 324 generates an authentication ID from the received hardware ID, login information, and installation time (S1020). The authentication ID generating section 324 supplies the generated authentication ID to the client-side authentication-data generating section 322.

Next, the user inputs a user ID and a password, in order to enable the user to utilize the started software. The user identification information acquiring section 336 acquires the user ID and the password input by the user (S1025). In addition, the user ID and the password are an example of user identification information. The user identification information acquiring section 336 supplies the acquired user ID and password to the client-side authentication-data generating section 322. The client-side authentication-data generating section 322 generates authentication data including the authentication ID and the password from the received authentication ID and password by means of a predetermined algorithm (S1030). The client-side control section 310 works on the client-side authentication-data generating section 322, and sends the authentication data and the user ID generated from the client-side authentication-data generating section 322 from the client-side communication section 300 to the server apparatus 20 (S1035).

The server apparatus 20 receives the authentication data including the authentication ID and the password sent from the client apparatus 30 and the user ID through the server-side communication section 200. The server-side communication section 200 supplies the received authentication data and user ID to the server-side control section 210. The server-side control section 210 compares the received user ID with a user ID stored on the authentication database 232, in order to acquire an authentication ID corresponding to the user ID (S1040). The server-side control section 210 supplies the acquired authentication ID to the server-side authentication-data generating section 222. Moreover, the server-side control section 210 compares the received user ID with the user ID stored on the authentication database 232, in order to acquire a password corresponding to the user ID (S1045). The server-side control section 210 supplies the acquired password to the server-side authentication-data generating section 222. Moreover, the server-side control section 210 supplies the authentication data received from the server-side communication section 200 to the authentication section 220.

The server-side authentication-data generating section 222 generates authentication data from the received authentication ID and password using the same algorithm as that of the client apparatus 30 (S1050). The server-side authentication-data generating section 222 supplies the generated authentication data to the authentication section 220. The authentication section 220 collates the authentication data, which is sent from the client apparatus 30 to the server apparatus 20 and is received from the server-side control section 210, with the authentication data received from the server-side authentication-data generating section 222, in order to perform user authentication (S1055). When the user authentication is denied in the authentication section 220 (S1055: No), the authentication section 220 supplies denial data, which is data showing that the user authentication has been denied, to the server-side control section 210. The server-side control section 210 sends the denial data from the server-side communication section 200 to the client apparatus 30 (S1060). Then, the server apparatus 20 terminates the process. When the client apparatus 30 receives the denial data through the client-side communication section 300, the client apparatus 30 supplies the denial data to the client-side control section 310. Then, the client-side control section 310 displays the effect that the user authentication has been denied on a display apparatus such as a monitor included in the client apparatus 30 as a denial result (S1065). Then, the client apparatus 30 terminates the process.

On the other hand, when the user authentication has been approved in the authentication section 220 (S1055: Yes), the authentication section 220 supplies approval data, which is data showing that the user authentication has been approved, to the server-side control section 210. The server-side control section 210 sends the approval data from the server-side communication section 200 to the client apparatus 30 (S1070). Moreover, when the user authentication has been approved, the server-side control section 210 makes the server-side authentication-data generating section 222 supply the authentication data generated from the server-side authentication-data generating section 222 to the server-side key generating section 240. The server-side key generating section 240 generates an encryption key and a decryption key from the received authentication data (S1075). The server-side key generating section 240 supplies the generated encryption key to the server-side encryption section 242 and the generated decryption key to the server-side decryption section 244. Then, the server apparatus 20 starts the client apparatus 30 and the encryption communication (S1090).

When the client-side communication section 300 receives the approval data, the client apparatus 30 supplies the approval data to the client-side control section 310. The client-side control section 310 displays the effect that the user authentication has been approved on a display apparatus such as a monitor included in the client apparatus 30 as an approval result (S1072). Then, the client-side control section 310 works on the client-side authentication-data generating section 322, and supplies the authentication data generated from the client-side authentication-data generating section 322 to the client-side key generating section 340. The client-side key generating section 340 generates an encryption key and a decryption key from the authentication data received from the client-side authentication-data generating section 322 (S1080). The client-side key generating section 340 supplies the generated encryption key to the client-side encryption section 342 and the generated decryption key to the client-side decryption section 344. Then, the client apparatus 30 starts the server apparatus 20 and the encryption communication (S1085). Until the encryption communication is released after starting the encryption communication between the server apparatus 20 and the client apparatus 30, all data transmitted and received between the server apparatus 20 and the client apparatus 30 may be encoded.

The file management system 10 according to the present embodiment can generate an authentication ID from the hardware ID inherent to the hardware included in the client apparatus and the installation time. Moreover, the file management system 10 can generate authentication data from the password and the authentication ID input by the user in the client apparatus, and collates the generated authentication data with the authentication data generated from the authentication ID and the password previously stored on the server apparatus to perform user authentication. In this way, although a third party attempts user authentication in the same client apparatus, it is possible to strongly prevent identity theft because the user authentication is not realized when both passwords are not identical with each other.

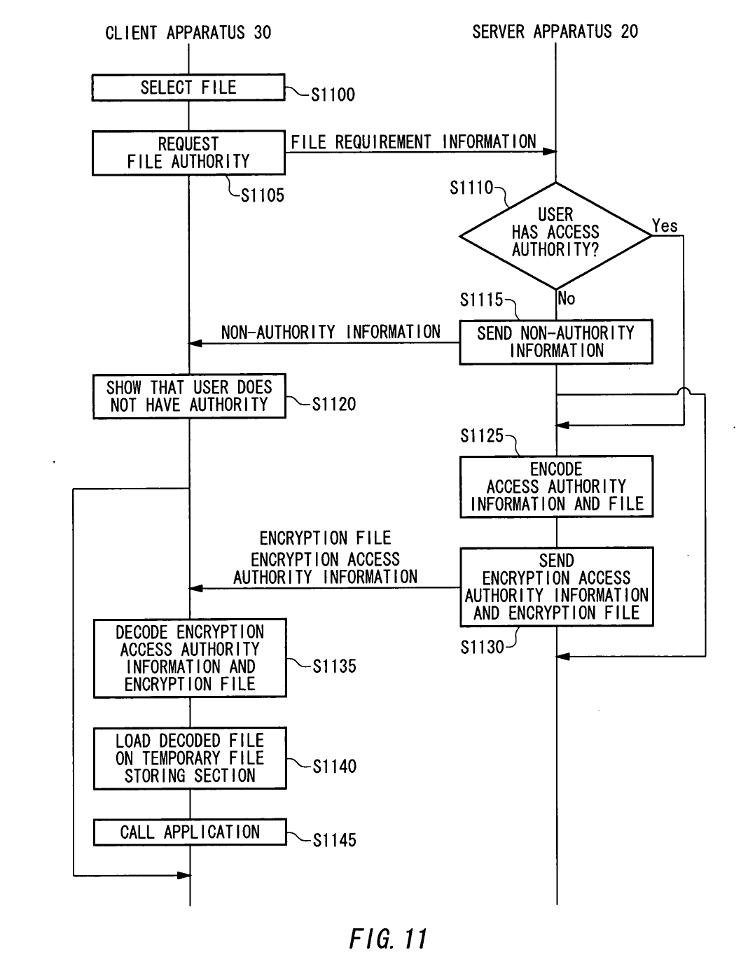

FIG. 11 is a view exemplary showing a flow of a process after starting the encryption communication in the file management system 10 according to the present embodiment. The user selects a desired file in the client apparatus 30 (S1100). The client-side control section 310 asks access authority given to the user in relation to the file selected by the user of the server apparatus 20 (S1105). For example, the client-side control section 310 sends access authority by which the user can operate the file as well as a file ID corresponding to the file selected by the user to the server apparatus 20 as file information requirement. Specifically, the client-side control section 310 sends the file information requirement from the client-side communication section 300 to the server apparatus 20. The server-side communication section 200 supplies the access authority request to the file and the file ID included in the file information requirement received from the client apparatus 30 to the server-side control section 210. The server-side control section 210 extracts access authority corresponding to the received file ID from the authority database 234, and decides whether the access authority to the file is given to the user (S1110).

When the user does not have access authority to the file selected by the user at all, the server-side control section 210 sends non-authority information showing that the user does not have access authority to the file to the client apparatus 30 via the server-side communication section 200 (S1115). The client apparatus 30 receives the non-authority information through the client-side communication section 300. Then, the client-side communication section 300 supplies the received non-authority information to the client-side control section 310. When the client-side control section 310 has received the non-authority information, the client-side control section 310 displays the effect that the user does not have access authority to the file selected by the user on a monitor or the like included in the client apparatus 30, in order to inform the user of the effect (S1120).

On the other hand, when the user has the access authority to the file selected by the user (S1110: Yes), the server-side control section 210 extracts the file selected by the user from the file server 250. Then, the server-side control section 210 supplies the extracted file and access authority to the file to the server-side encryption section 242. The server-side encryption section 242 encodes the received file and access authority (S1125). The server-side encryption section 242 supplies encryption file that is the encoded file and encryption access authority information that is the encoded access authority information to the server-side control section 210. The server-side control section 210 that has received the encryption file and the encryption access authority information sends the encryption file and the encryption access authority information to the client apparatus 30 via the server-side communication section 200 (S1130).

The client-side communication section 300 receives the encryption file and the encryption access authority information from the server apparatus 20. The client-side communication section 300 supplies the received encryption file and encryption access authority information to the client-side control section 310. The client-side control section 310 supplies the received encryption file and encryption access authority information to the client-side decryption section 344. The client-side decryption section 344 decodes the received encryption file and encryption access authority information (S1135). The client-side control section 310 makes the client-side decryption section 344 supply the decoded file to the temporary file storing section 360 and the decoded access authority information to the authority loading section 370. The client-side control section 310 loads the decoded file on the temporary file storing section 360 (S1140). Then, the client-side control section 310 works on the operating system control section 312, and calls out an application handling the file selected by the user (S1145).

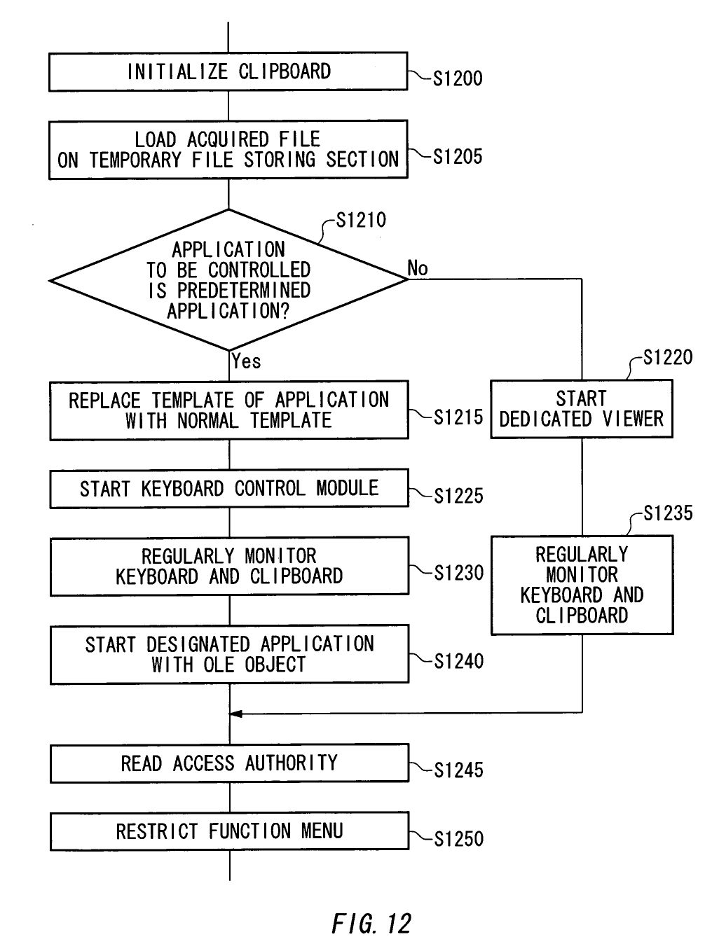

FIG. 12 is a view exemplary showing a flow of a process in application control according to the present embodiment. At first, the client-side control section 310 initializes a clipboard for temporarily saving data for which a copy operation and a cut operation have been performed (S1200). Then, the client-side control section 310 loads the file acquired from the server apparatus 20 on the temporary file storing section 360 (S1205). Subsequently, the client-side control section 310 decides whether the application to be controlled is a predetermined application (S1210). For example, the client-side control section 310 may decide whether the application handling the file is a predetermined application based on an extension of the file. In addition, the application may be, e.g., MS-Office (a registered trademark).

When it is decided that the application is a predetermined application (S1210: Yes), the client-side control section 310 replaces a template of the application with a normal template (S1215). For example, an office template is replaced with a normal template when the application is MS-Office (a registered trademark). Then, the client-side control section 310 works on the operating system control section 312, and starts a keyboard controlling module for controlling a keyboard so that an operation for the keyboard is not transmitted to the operating system in order to station the module in the client apparatus 30 (S1225). Moreover, the client-side control section 310 works on the operating system control section 312, and regularly monitors a keyboard operation taking out data using a control key and API calling the clipboard (S1230). Subsequently, the client-side control section 310 starts a designated application with an OLE object (S1240). Specifically, the client-side control section 310 starts an application associated with an extension or the like of a file in association with the file.

On the other hand, when the application is not a predetermined application (S1210: No), the client-side control section 310 works on the operating system control section 312, and starts a dedicated Viewer (S1220). Files not associated with a predetermined application may be, e.g., a file of a PDF format and a text file. Then, the client-side control section 310 works on the operating system control section 312, and regularly monitors a keyboard operation taking out data using a control key and API calling the clipboard (S1235).

Then, the client-side control section 310 causes the authority loading section 370 to load access authority to the file selected by the user. The application controlling section 380 reads the access authority loaded from the authority loading section 370 (S1245). The application controlling section 380 restricts a functional menu of the application program based on the read access authority (S1250). For example, the application controlling section 380 grays out other functional menus exceeding the access authority given to the user to be unable to select the menus. Moreover, the application controlling section 380 may control the application program so that editing menus corresponding to the access authority not given to the user are not displayed.

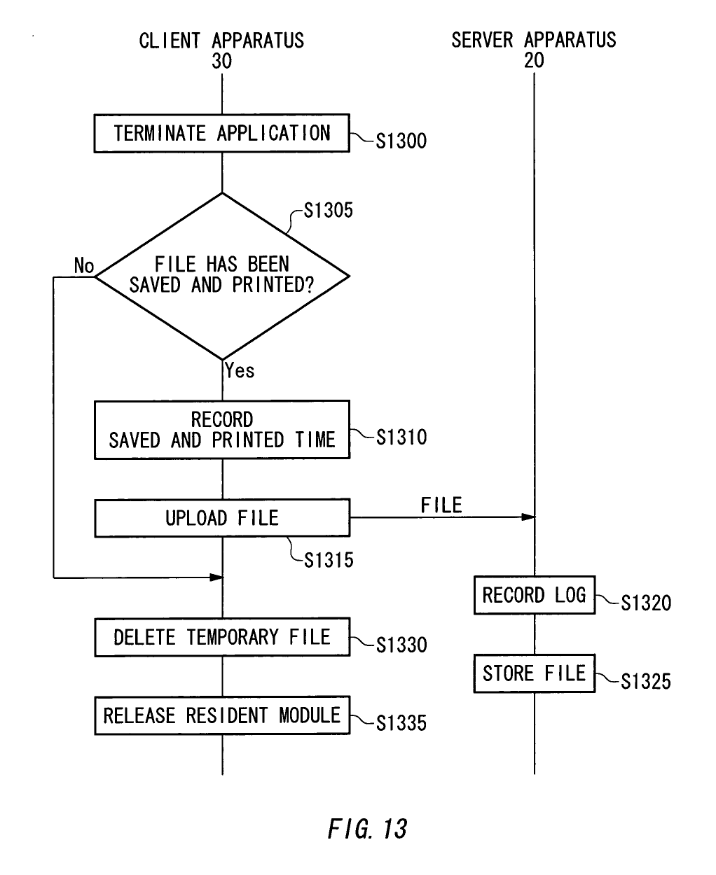

FIG. 13 is a view exemplary showing a file updating flow according to the present embodiment. At first, the user terminates the use of application program in the client apparatus 30 (S1300). Then, the client-side control section 310 decides whether the user has performed archiving and printing operations on the file selected by the user (S1305). When the user has saved and printed the file, the user records the time at which the file has been saved and printed as a log file (S1310). Then, the client-side control section 310 uploads the file edited by the user and the log data to the server apparatus 20 via the client-side communication section 300 (S1315). The server apparatus 20 receives the file and the log file from the client apparatus 30. The server-side control section 210 works on the file server 250 to make the log database 238 record the log data (S1320). Moreover, the server-side control section 210 stores the received updated file on the file server 250. Then, the file server 250 supplies a file position, at which the updated file is stored, to the file information database 236, to store it.

Then, after uploading the file and when the user does not perform archiving and printing operations of the file (S1305: No), the client-side control section 310 deletes the temporary file loaded on the temporary file storing section 360 (S1330). For example, the client-side control section 310 overwrites a new file on the temporary file to be unable to access the temporary file that has been utilized by the user. Moreover, after a new file has been overwritten on the temporary file, the client-side control section 310 may delete the overwritten file. Subsequently, the client-side control section 310 works on the operating system control section 312, and releases the resident keyboard controlling module (S1335).

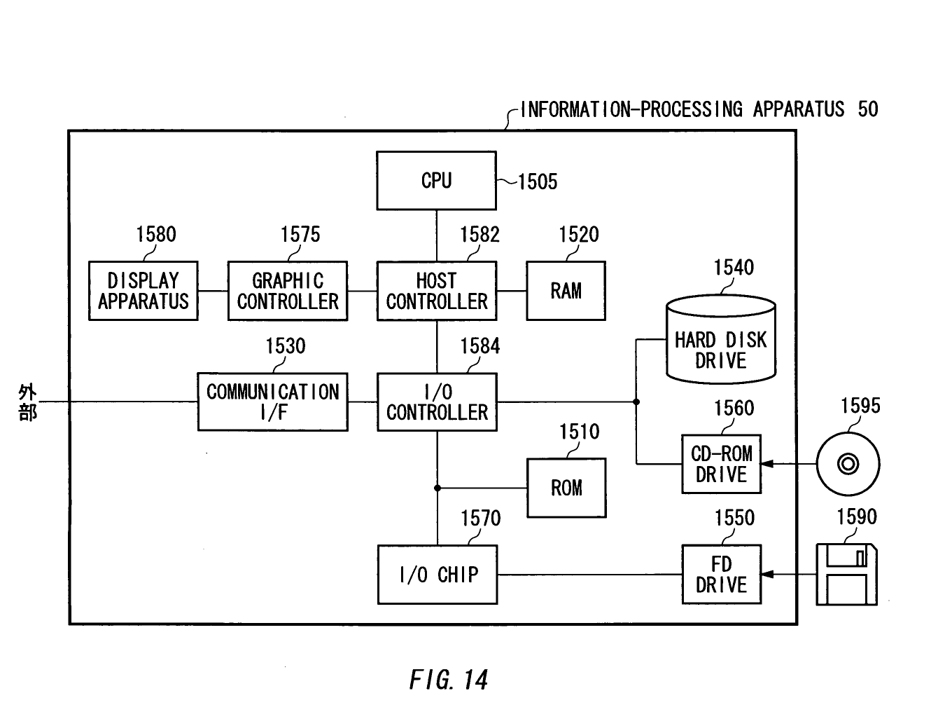

FIG. 14 is a view exemplary showing a hardware configuration of the information processing apparatus 50 according to the fourth embodiment of the present invention. In addition, the information processing apparatus 50 functions as at least a part of functions realized by the server apparatus 20 shown in FIG. 2 and the client apparatus 30 shown in FIG. 8. Moreover, these functional configurations may be provided as software by means of a program stored on a recording medium.

The information processing apparatus 50 according to the present embodiment includes a CPU peripheral section having a CPU 1505, a RAM 1520, a graphic controller 1575, and a display apparatus 1580 interconnected by a host controller 1582, an input-output section having a communication interface 1530, a hard disk drive 1540, and a CD-ROM drive 1560 connected to the host controller 1582 by an input-output controller 1584, and a legacy input-output section having a ROM 1510, a flexible disk drive 1550, and an input-output chip 1570 connected to the input-output controller 1584.

The host controller 1582 connects the RAM 1520 to the CPU 1505 accessing the RAM 1520 at high transfer rate and the graphic controller 1575. The CPU 1505 operates based on a program stored on the ROM 1510 and the RAM 1520, and controls each section. The graphic controller 1575 acquires image data that the CPU 1505 or the like generates on a frame buffer provided in the RAM 1520, in order to display the image data on the display apparatus 1580. Alternatively, the graphic controller 1575 may include therein a frame buffer storing the image data generated from the CPU 1505 or the like.

The input-output controller 1584 connects the host controller 1582 to the communication interface 1530, the hard disk drive 1540, and the CD-ROM drive 1560 that area comparatively high-speed input-output apparatus. The communication interface 1530 communicates with other apparatuses through a network. The hard disk drive 1540 stores a program and data used by the CPU 1505 in the information processing apparatus 50. The CD-ROM drive 1560 reads the program or the data from a CD-ROM 1595, and provides the program or the data to the hard disk drive 1540 via the RAM 1520.

Moreover, the input-output controller 1584 is connected to the ROM 1510, the flexible disk drive 1550, and the input-output chip 1570 that are a comparatively low-speed input-output apparatus. The ROM 1510 stores thereon a boot program executed during starting the information processing apparatus 50 and a program dependent on hardware in the information processing apparatus 50. The flexible disk drive 1550 reads a program or data from the flexible disk 1590, and provides the program or the data to the hard disk drive 1540 via the RAM 1520. The input-output chip 1570 connects various input-output apparatuses through the flexible disk drive 1550, e.g., a parallel port, a serial port, a keyboard port, a mouse port, and so on.

An information processing program to be provided to the hard disk drive 1540 through the RAM 1520 is stored on a recording medium such as the flexible disk 1590, the CD-ROM 1595, or an IC card, and is provided by a user. The information processing program is read from the recording medium, is installed in the hard disk drive 1540 in the information processing apparatus 50 via the RAM 1520, and is executed in the CPU 1505. The information processing program installed and executed in the information processing apparatus 50 works on the CPU 1505 or the like, and makes the information processing apparatus 50 function as the server-side communication section 200, the server-side control section 210, the authentication section 220, the server-side authentication-data generating section 222, the database group 230, the server-side key generating section 240, the server-side encryption section 242, the server-side decryption section 244, the file server 250, the authentication database 232, the authority database 234, the file information database 236, and the log database 238, which are described in FIGS. 1 to 13. Moreover, the information processing program installed and executed in the information processing apparatus 50 works on the CPU 1505 or the like, and makes the information processing apparatus 50 function as the client-side communication section 300, the client-side control section 310, the operating system control section 312, the client-side authentication section 320, the hardware ID acquiring section 330, the installation time storing section 332, the login information acquiring section 334, the user identification information acquiring section 336, the client-side key generating section 340, the client-side encryption section 342, the client-side decryption section 344, the authority input controlling section 350, the authority setting section 352, the authority setting approving section 354, the temporary file storing section 360, the authority loading section 370, the application controlling section 380, the application program 390, the operating system 392, the client-side authentication-data generating section 322, and the authentication ID generating section 324, which are described in FIGS. 1 to 13.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

What is claimed is:

1. A file management system that makes a user under a client apparatus utilize a file stored on a server apparatus,
the server apparatus comprising:
a file information database for storing a file position in association with a file name;
a file server for storing a file at a file position stored on said file information database;
an authority database for storing access authority information indicative of access authority to a file for each user in association with a plurality of file names stored on said file information database; and
a server-side communication section for sending the file stored on said file server and the access authority information stored on said authority database to the client apparatus, and
the client apparatus comprising:
a client-side communication section for receiving the file and the access authority information sent from said server-side communication section;
an application program for making a user utilize the file received by said client-side communication section; and
an application controlling section for restricting a function of an application capable of being utilized by the user based on the access authority information received by said client-side communication section when the user utilizes the file received by said client-side communication section.

2. The file management system as claimed in claim 1, wherein
the client apparatus further comprises an operating system for controlling operations of said application program, and
said application controlling section restricts a function of said utilizable application program by controlling said application program without controlling said operating system.

3. The file management system as claimed in claim 1, wherein said application controlling section restricts a function of said utilizable application program by controlling said application program so that at least a part of function menus displayed by said application program cannot be selected, based on the access authority information received by said client-side communication section.

4. The file management system as claimed in claim 3, wherein said application controlling section restricts a function of said utilizable application program by graying out at least a part of function menus displayed by said application program, based on the access authority information received by said client-side communication section.

5. The file management system as claimed in claim 1, wherein
the client apparatus further comprises:
a hardware ID acquiring section for acquiring a hardware ID identifying a hardware included in the client apparatus;
an authentication ID generating section for generating an authentication ID from the hardware ID acquired by said hardware ID acquiring section; and
a client-side authentication-data generating section for generating authentication data including the authentication ID generated from said authentication ID generating section,
said client-side communication section sends the authentication data generated from said client-side authentication-data generating section to the server apparatus,
said server-side communication section receives the authentication data sent from said client-side communication section sent,
the server apparatus further comprises:
an authentication database for previously storing authentication ID every user;
a server-side authentication-data generating section for generating authentication data including the authentication ID stored on said authentication database; and
an authentication section for deciding whether the authentication data received by said server-side communication section is identical with the authentication data generated from said server-side authentication-data generating section, in order to perform authentication, and said server-side communication section sends the file stored on said file server and the access authority information stored on said authority database to the client apparatus when the authentication by said authentication section has been performed successfully.

6. The file management system as claimed in claim 5, wherein
said authentication database stores the authentication ID in association with user identification information identifying the user,
said client-side communication section sends the authentication data generated from said client-side authentication-data generating section to the server apparatus,
said server-side communication section receives the authentication data sent from said client-side communication section, and
said server-side authentication-data generating section generates authentication data including the authentication ID stored on said authentication database in association with the user identification information included in the authentication data received by said server-side communication section.

7. The file management system as claimed in claim 6, wherein
said client-side authentication-data generating section generates authentication data including the authentication ID generated from said authentication ID generating section and a password input from the user,
said client-side communication section sends the authentication data generated from said client-side authentication-data generating section to the server apparatus,
said server-side communication section receives the authentication data sent from said client-side communication section, and
said server-side authentication-data generating section generates authentication data including the authentication ID and a password stored on said authentication database.

8. The file management system as claimed in claim 5, wherein
the client apparatus further comprises an installation time storing section for storing the time at which a software functioning as said application controlling section is installed, and
said authentication ID generating section generates an authentication ID from the installation time stored on said installation time storing section and the hardware ID acquired by said hardware ID acquiring section.

9. The file management system as claimed in claim 8, wherein
the client apparatus further comprises:
an operating system for controlling operations of said application program; and
a login information acquiring section for acquiring login information input from the user when logging in said operating system, and
said authentication ID generating section generates an authentication ID from the login information acquired by said login information acquiring section, the installation time stored on said installation time storing section, and the hardware ID acquired by said hardware ID acquiring section.

10. The file management system as claimed in claim 5, wherein
the client apparatus further comprises:
a client-side key generating section for generating an encryption key and a decryption key from the authentication data generated from said client-side authentication-data generating section;
a client-side encryption section for encoding data to be sent from said client-side communication section to the server apparatus by means of the encryption key generated from said client-side key generating section; and
a client-side decryption section for decoding data received by said client-side communication section from the server apparatus by means of the decryption key generated from said client-side key generating section, and
the server apparatus further comprises:
a server-side key generating section for generating an encryption key and a decryption key from the authentication data generated from said server-side authentication-data generating section;
a server-side encryption section for encoding data to be sent from said server-side communication section to the client apparatus by means of the encryption key generated from said server-side key generating section; and
a server-side decryption section for decoding data received by said server-side communication section from the client apparatus by means of the decryption key generated from said server-side key generating section.

11. The file management system as claimed in claim 1, wherein said application controlling section loads the file received by said client-side communication section as a temporary file, in order to make said application program utilize the file.

12. The file management system as claimed in claim 11, wherein said application controlling section sends, when the user requests the storage of a file loaded as a temporary file, the file from said client-side communication section to the server apparatus to save the file in said file server and then overwrites thereon the file loaded as the temporary file to be a new file.

13. The file management system as claimed in claim 1, wherein
the client apparatus further comprises:
an authority input controlling section for making the user input access authority to the file stored on said authority database; and
an authority setting section for making said client-side communication section send access authority information indicative of the access authority input by the user to the server apparatus, in order to make said authority database record therein the access authority information.

14. The file management system as claimed in claim 13, wherein the client apparatus or the server apparatus further comprises an authority setting approving section for permitting the user, to which predetermined access authority is given, to give access authority more restricted than the predetermined access authority to another user.

15. The file management system as claimed in claim 14, wherein
said file server stores a file classified into folders, and
said authority setting approving section permits a folder administrator that is an administrator of a folder to give access authority to a file in the folder to another user.

16. The file management system as claimed in claim 14, wherein said authority setting approving section permits a file creator that is a creator of a file to give access authority to the file to another user.

17. The file management system as claimed in claim 14, wherein said authority setting approving section permits a server administrator that is an administrator of the server apparatus to give access authority to the file stored on said authority database to another user.

18. An information processing apparatus comprising:
a communication section for receiving a file stored on a file server and access authority information indicative of access authority to the file stored on an authority database in association with the file;
an application program for making a user utilize the file received by said communication section; and
an application controlling section for restricting a function of an application capable of being utilized by the user based on the access authority information received by said communication section when the user utilizes the file received by said communication section.

19. An authentication system that authenticates a user of software installed in a client apparatus in a server apparatus, comprising:
a hardware ID acquiring section for acquiring a hardware ID identifying hardware included in the client apparatus;
an installation time storing section for storing time at which the software is installed in the client apparatus;
an authentication ID generating section for generating an authentication ID from the hardware ID acquired by said hardware ID acquiring section and the installation time stored on said installation time storing section;
a first authentication-data generating section for generating authentication data from the authentication ID generated from said authentication ID generating section;
an authentication database for previously storing an authentication ID every user;
a second authentication-data generating section for generating authentication data from the authentication ID stored on said authentication database; and
an authentication section for deciding whether the authentication data generated from said first authentication-data generating section is identical with the authentication data generated from said second authentication-data generating section, in order to perform authentication.

20. A file access authority setting system comprising:
a file information database for storing a file position in association with a file name;
a file server for storing a file at the file position stored on said file information database;
an authority database for storing access authority information indicative of access authority to a file for each user in association with a plurality of file names stored on said file information database;
an authority input controlling section for making a user input access authority to the file stored on said file server;
an authority setting section for making said authority database record access authority information indicative of the access authority input by the user; and
an authority setting approving section for permitting the user, to which predetermined access authority is given by the access authority information stored on said authority database, to give access authority more restricted than the predetermined access authority to another user.
